(19) United States
(12) Patent Application Publication
(10) Pub. No.: US 2009/0128038 A1
(43) Pub. Date: May 21, 2009

(54) Light-emitting discharge tube, method of fabricating the same, and protective film forming apparatus

(76) Inventors: Hitoshi Yamada, Kawasaki (JP); Akira Tokai, Kawasaki (JP); Manabu Ishimoto, Kawasaki (JP); Yosuke Yamazaki, Kawasaki (JP); Kenji Awamoto, Kawasaki (JP); Koji Shinohe, Kawasaki (JP); Hitoshi Hirakawa, Kawasaki (JP)

Correspondence Address: STAAS & HALSEY LLP, SUITE 700, 1201 NEW YORK AVENUE, N.W., WASHINGTON, DC, 20005, US

(21) Appl. No.: 12/320,125

(22) Filed: Jan. 16, 2009

Related U.S. Application Data
(62) Division of application No. 11/399,629, filed on Apr. 7, 2006.

(30) Foreign Application Priority Data
Oct. 10, 2003 (JP) PCT/JP2003/013098

(51) Int. Cl. H01J 65/00

(52) U.S. Cl. 313/607

(57) ABSTRACT

A light-emitting discharge tube in which an outer wall surface of a glass tube is made less susceptible to flaws by forming a protective film on the outer wall surface of the glass tube, a method of fabricating the light-emitting discharge tube, and a protective film forming apparatus are provided. The light-emitting discharge tube defines light-emitting discharge regions by a plurality of external electrodes. The outer wall surface of the light-emitting discharge tube (the glass tube) is coated with the protective film (a metal film, a conductive metal oxide film, an insulating metal oxide film, or an organic film).

This application is a continuation of PCT International Application No. PCT/JP2003/013098 which has an International filing date of Oct. 10, 2003, which designated the United States of America.

### TECHNICAL FIELD

The present invention relates to a light-emitting discharge tube, a method of fabricating the light-emitting discharge tube, and a protective film forming apparatus that forms a protective film on a surface of the light-emitting discharge tube.

### BACKGROUND ART

A light-emitting discharge tube that causes a gas discharge to occur by the application of a voltage from external electrodes and emits light by a phosphor contained inside thereof is proposed for use in display devices (see Japanese Patent Application Laid-Open No. 2003-86141, for example). Such a light-emitting discharge tube uses a glass tube having, for example, a length of 300 mm or more, and an outside diameter of 2 mm or less, and a wall thickness of 0.1 mm or less. Since the length of the light-emitting discharge tube is extremely long relative to the outside diameter and the wall thickness is also thin, there are problems that the glass tube is susceptible to breakage during the fabrication process and a fabricated light-emitting discharge tube is also susceptible to breakage.

The reasons that conventional light-emitting discharge tubes are susceptible to breakage are examined. It is found that a surface of a glass tube is flawed during the fabrication process and a force is applied to the flaw part, thereby causing breakage. Flaws to the surface of the glass tube are easily caused during the fabrication process of the light-emitting discharge tube because the glass tube is extremely long and thin and has a thin wall thickness. Therefore, even if a light-emitting discharge tube is fabricated with the greatest care, it is very difficult to make the surface flawless.

### DISCLOSURE OF THE INVENTION

The present invention is made in view of the foregoing problems. An object of the present invention is to provide a light-emitting discharge tube in which an outer wall surface of a glass tube is made less susceptible to flaws by forming a protective film on the outer wall surface of the glass tube, and a method of fabricating such a light-emitting discharge tube.

Another object of the present invention is to provide a protective film forming apparatus for forming a protective film on a surface of a light-emitting discharge tube.

A light-emitting discharge tube according to one aspect of the present invention is directed to a light-emitting discharge tube that defines light-emitting discharge regions by a plurality of external electrodes, wherein an outer wall surface of the light-emitting discharge tube is coated with a protective film. A method of fabricating a light-emitting discharge tube according to another aspect of the present invention is directed to a method of fabricating a light-emitting discharge tube that defines light-emitting discharge regions by at least two external electrodes, the method comprising the steps of forming a tube body for a light-emitting discharge tube by stretching a tubular base material; coating a protective film on a surface of the tube body for a light-emitting discharge tube; and filling a discharge gas into the tube body for a light-emitting discharge tube.

In the light-emitting discharge tube and the method of fabricating a light-emitting discharge tube according to the present invention, by coating an outer wall surface of a light-emitting discharge tube with a protective film, the outer wall surface is prevented from being flawed, and accordingly, the light-emitting discharge tube is prevented from being broken.

In the light-emitting discharge tube and the method of fabricating a light-emitting discharge tube according to the present invention, the protective film may be a metal film, a conductive metal oxide film, an insulating metal oxide film, or an organic film.

In the light-emitting discharge tube and the method of fabricating a light-emitting discharge tube according to the present invention, since the protective film is composed of a metal film, a conductive metal oxide film, an insulating metal oxide film, or an organic film, a protective film with good controllability and good film quality is formed.

In the light-emitting discharge tube and the method of fabricating a light-emitting discharge tube according to the present invention, the metal film or the conductive metal oxide film may be subjected to patterning to form the external electrodes.

In the present invention, since a metal film or a conductive metal oxide film is formed into external electrodes, the formation of external electrodes is facilitated, and furthermore, the fabrication costs can be reduced.

In the method of fabricating a light-emitting discharge tube according to the present invention, the step of coating a protective film may take place successively after the step of forming a tube body for a light-emitting discharge tube.

In the present invention, since the step of coating and forming a protective film is provided successively after the step of forming a tube body for a light-emitting discharge tube, the protective action of the protective film is fully exerted.

In the method of fabricating a light-emitting discharge tube according to the present invention, the conductive metal oxide film or the insulating metal oxide film may be formed using an organometallic compound solution that becomes a conductive metal oxide film or an insulating metal oxide film by calcination.

In the present invention, since an organometallic compound solution that becomes a metal oxide film by calcination is used, the formation of a protective film can be precisely controlled and a protective film with good film quality is formed.

A protective film forming apparatus according to still another aspect of the present invention is directed to a protective film forming apparatus that forms a protective film on a surface of a tube body for a light-emitting discharge tube, the tube body being formed by stretching a tubular base material, the apparatus comprising: a frame body having a through portion through which the tube body for a light-emitting discharge tube can pass, and which can hold a liquid that is a material of the protective film. In the protective film forming apparatus according to the present invention, the frame body may have provided therein a supply passage for supplying the liquid from outside.

In the present invention, by passing the tube body for a light-emitting discharge tube through the through portion that can hold a liquid that is a material of the protective film, a protective film is coated and formed; accordingly, a protective film forming apparatus with a simple structure that is capable of precisely controlling the formation of a protective film is provided.

According to the present invention, since a protective film is formed on an outer wall surface of a glass tube, the outer wall surface of the glass tube can be prevented from being flawed, and accordingly, a light-emitting discharge tube with a high fabrication yield, excellent discharge characteristics, and high reliability, and a method of fabricating such a light-emitting discharge tube can be provided. In particular, significant effects are exerted on a light-emitting discharge tube using a long and thin glass tube with a thin wall thickness.

Moreover, a protective film forming apparatus with a simple structure that can precisely control and form a protective film of a light-emitting discharge tube can be provided.

### BRIEF DESCRIPTION OF THE DRAWINGS

FIG. 1 is a schematic cross-sectional view of a light-emitting discharge tube according to a first embodiment of the present invention.

FIG. 2 is a schematic plan view of the light-emitting discharge tube of FIG. 1 as viewed from its upper flat side.

FIG. 3 is a schematic perspective view of a light-emitting discharge tube array having a plurality of light-emitting discharge tubes of FIG. 1 arranged in parallel.

FIG. 4 is a schematic process flowchart of a method of fabricating a light-emitting discharge tube, according to a second embodiment of the present invention.

FIG. 5 is a schematic process flowchart of a method of fabricating a light-emitting discharge tube, according to a third embodiment of the present invention.

FIG. 6 is a schematic process flowchart of a method of fabricating a light-emitting discharge tube, according to a fourth embodiment of the present invention.

FIG. 7 is an illustrative view of a configuration of a protective film of a glass tube, according to a first example of the present invention.

FIG. 8 is an illustrative view of a configuration of a protective film of a glass tube, according to a second example of the present invention.

FIG. 9 is a schematic perspective view of a protective film forming apparatus according to a fifth embodiment of the present invention.

### BEST MODE FOR IMPLEMENTING THE INVENTION

The present invention will be described in detail below with reference to the drawings showing the embodiments thereof.

### First Embodiment

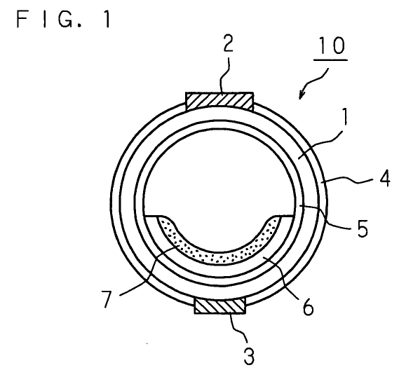

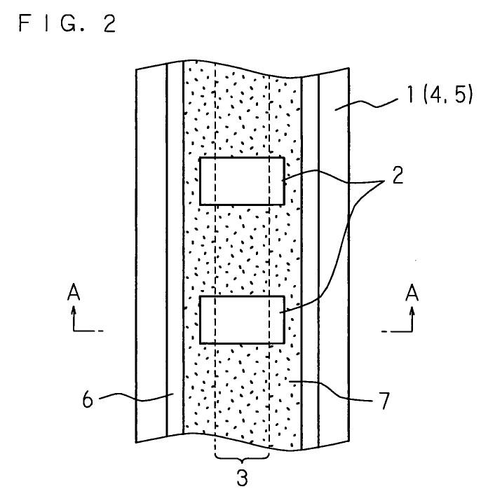

FIG. 1 is a schematic cross-sectional view of a light-emitting discharge tube according to a first embodiment of the present invention. FIG. 2 is a schematic plan view of the light-emitting discharge tube of FIG. 1 as viewed from its upper flat side. FIG. 1 is a cross-sectional view taken in the direction of arrow AA of FIG. 2.

A light-emitting discharge tube 10 has discharge electrodes 2 on a front side of an outer wall surface of a glass tube (tube body for a light-emitting discharge tube) 1 and an address electrode 3 on a back side thereof. The glass tube 1 has dimensions, for example, with a length of 300 mm or more, a tube outside diameter of 2 mm or less, and a tube wall thickness of 0.1 mm or less, and is formed of borosilicate glass or the like. The cross-section of the glass tube 1 is not limited to circular as shown in the drawing and may be in the shape of a flat ellipse. Inside the glass tube 1, a discharge gas, such as xenon (Xe) or neon (Ne), for example, is filled at an appropriate pressure.

The discharge electrodes 2 and the address electrode 3 are formed on the outer wall surface of the glass tube 1 and compose external electrodes. The light-emitting discharge of the light-emitting discharge tube 10 is controlled by a voltage applied to the discharge electrodes 2 and the address electrode 3. By applying an appropriate discharge voltage to the external electrodes a discharge voltage can be applied to the discharge gas filled in the glass tube 1, and a discharge (light emission) occurs in predetermined regions (discharge regions) that are defined by the positions of the external electrodes. A plurality of discharge electrodes 2 are formed in a rectangular shape so as to be separated from one another in a tube axis direction of the glass tube 1. The address electrode 3 is formed linearly in the tube axis direction of the glass tube 1.

In the case of the glass tube 1 shown in the drawings, it is configured such that a light-emitting discharge (plane discharge) occurs between a pair of discharge electrodes 2, 2 (a discharge region). By forming multiple pairs of discharge electrodes (2, 2) in the tube axis direction of the glass tube 1 to form a multiplicity of discharge regions, the light-emitting discharge tube 10 having a multiplicity of light-emitting points in the single glass tube 1 is configured.

A large spacing is provided between the discharge electrodes 2, 2 shown in the drawing and an adjacent discharge electrode (2) which is not shown, so as to prevent a light-emitting discharge from occurring between discharge regions. By this, a region (discharge region) where a light-emitting discharge occurs is delimited and discharge control is performed. The external electrodes are not limited to a three-electrode system as shown in the drawing, and may employ an electrode configuration (two-electrode system) that causes a counter discharge between a single discharge electrode 2 and an address electrode 3.

A protective film 4 is formed on the outer wall surface of the glass tube 1 and an electron emission film 5 is formed on an inner wall surface. In addition, inside the glass tube 1 are formed a phosphor 7 for converting a discharge into a light emission of a predetermined color and a support member 6 that supports the phosphor 7. Note that for ease of understanding, hatch lines that represent cross-sections are omitted for the glass tube 1, the protective film 4, the electron emission film 5, the support member 6, and the phosphor 7.

The protective film 4 is a film formed for protecting the outer wall surface of the glass tube 1 and is formed of, for example, a metal film, a metal oxide film, or an organic film. When the protective film has conductivity, the protective film is formed to be separated from the external electrodes (the discharge electrode 2 and the address electrode 3). When the protective film does not have conductivity, the external electrodes may be formed to be overlaid (stacked) on the protective film, or, as shown in the drawing, the external electrodes may be formed in portions where the protective film is removed. Since the outer wall surface of the glass tube 1 is protected by the protective film 4, the outer wall surface is less susceptible to flaws and thus the light-emitting discharge tube 10 which is less susceptible to breakage is provided. Furthermore, during the fabrication process, the light-emitting discharge tube 10 is less susceptible to flaws and has a high yield.

The electron emission film 5 is a film for emitting charged particles into space of the glass tube 1 by a collision with a discharge gas having energy above a given value, to enhance (improve) discharge characteristics. The electron emission film 5, however, is not necessarily needed.

The support member 6 is a member for holding the phosphor 7 and is normally formed of the same material as the glass tube 1 so as to be connected to the glass tube 1. The support member 6 allows the phosphor 7 to be stacked and held on its top (the space side of the glass tube 1). The phosphor 7 converts a vacuum ultraviolet light generated during a process where a discharge gas (excited rare-gas atoms) which is excited by a voltage applied between the external electrodes is de-excited, into a visible light and allows the glass tube 1 to act as the light-emitting discharge tube 10. The support member 6 and the phosphor 7 are not necessarily needed, depending on the type of discharge gas and the configuration of the light-emitting discharge tube 10.

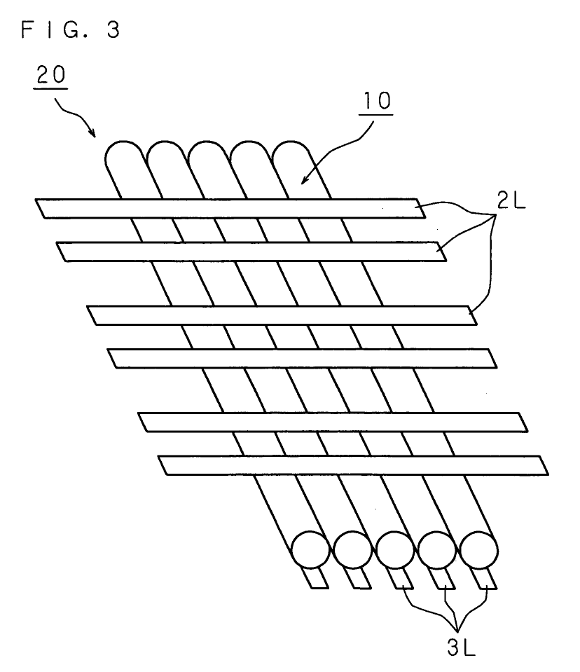

FIG. 3 is a schematic perspective view of a light-emitting discharge tube array having a plurality of light-emitting discharge tubes of FIG. 1 arranged in parallel. A plurality of light-emitting discharge tubes 10 are arranged in parallel to form a light-emitting discharge tube array 20. The light-emitting discharge tube array 20 can serve as a backlight applicable to flat-panel display devices, liquid crystal display devices, and the like. On the front side where discharge electrodes (2) are formed are provided leads 2L for discharge electrodes that interconnect the discharge electrodes (2) of the light-emitting discharge tubes 10 and that allow a voltage for discharge to be applied to the discharge electrodes (2) from the outside. On the back side too where address electrodes (3) are formed are provided leads 3L for address electrodes that allow a voltage for discharge to be applied to the address electrodes (3) from the outside. Note that by forming each group of the leads 2L for discharge electrodes and the leads 3L for address electrodes into an integral structure by printing a conductive material on a resin film (not shown), a light-emitting discharge tube array having a simpler structure and being easy to use can be made.

### Second Embodiment

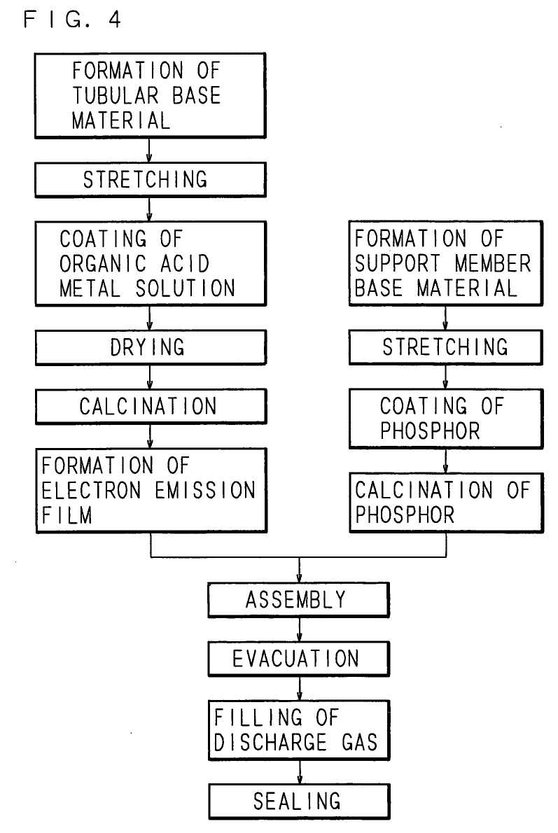

FIG. 4 is a schematic process flowchart of a method of fabricating a light-emitting discharge tube, according to a second embodiment of the present invention. First, a tubular base material is formed. The tubular base material is stretched (redrawn) to form a tube body (glass tube 1) for a light-emitting discharge tube. There are no flaws on a surface (outer wall) of the glass tube 1 just after formed. Thus, a protective film 4 is coated and formed on the outer wall surface of the glass tube 1 successively just after the glass tube 1 is formed (that is, before proceeding to another step). Since the protective film 4 is successively coated and formed on the outer wall surface of the glass tube 1 just after formed, the outer wall surface of the glass tube 1 can be protected from external forces in subsequent processes, ensuring surface protection.

In the present embodiment, as the protective film 4, an organic acid metal solution (organometallic compound solution) is coated. For the organic acid metal solution, a material that becomes an insulating metal oxide film by calcination is used. The coating method includes a method of allowing a tube to pass through a coating solution, a method that uses a coating apparatus such as a roll coater, and the like, but is not particularly limited as long as the method allows the protective film 4 of a predetermined film thickness to be uniformly formed on the surface of the glass tube 1.

Subsequently, the protective film 4 is dried and then calcined. The drying conditions and the calcination conditions are appropriately set, depending on the type of organic acid metal solution to be used and the condition of the solution. Since the protective film 4 becomes a metal oxide film by calcination, a dense, stable metal oxide film with good film quality can be formed. Thereafter, an electron emission film 5 is formed on an inner wall surface of the glass tube 1 on which the metal oxide film is formed by calcination.

Meanwhile, a support member base material is formed to form a support member 6. By stretching (redrawing) the support member base material, the support member 6 is formed. By coating and calcining a material of a phosphor 7 on a top (the space side of the glass tube 1) of the support member 6, the support member 6 is configured to allow the phosphor 7 to be stacked and held on the support member 6.

Thereafter, the glass tube 1 and the support member 6 are assembled. By adjusting in advance the shape of the support member 6 and the shape of the glass tube 1 to match each other, a light-emitting discharge tube 10 with better discharge characteristics can be formed. After assembling the glass tube 1 and the support member 6 on which the phosphor 7 is formed, evacuation and filling of a discharge gas are performed and sealing is done. By, after sealing, appropriately forming external electrodes, the light-emitting discharge tube 10 can be obtained.

In the present embodiment, since the protective film 4 is an insulating metal oxide film, the external electrodes may be formed on a surface of the protective film 4 or may be formed after the protective film 4 is appropriately subjected to patterning. Since the outer wall surface is coated with an insulating metal oxide film, the outer wall surface of the glass tube 1 is less susceptible to flaws, and accordingly, the glass tube 1 is less susceptible to breakage. That is, the fabrication yield of the light-emitting discharge tube 10 can be improved. Furthermore, the influence of handing during the fabrication process can be reduced and thus handling is facilitated, increasing handling flexibility.

### Third Embodiment

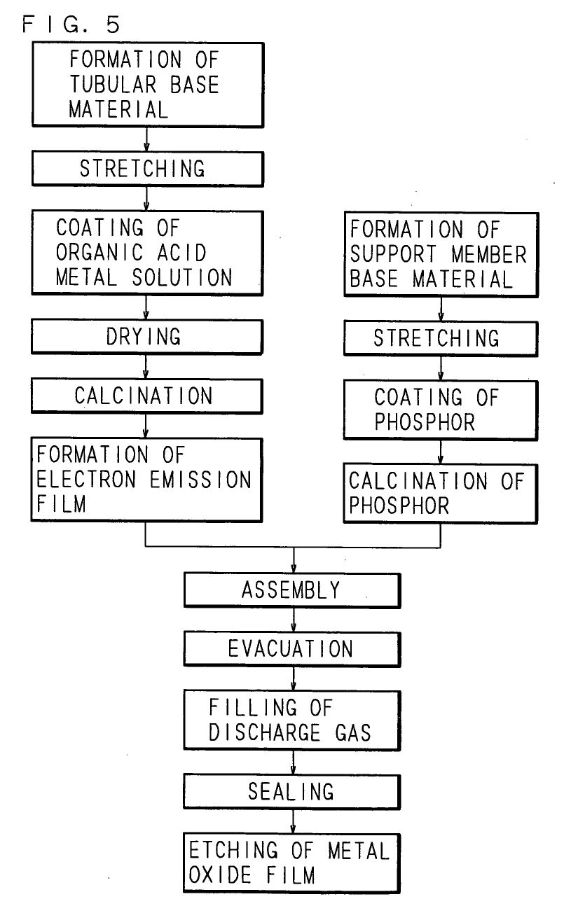

FIG. 5 is a schematic process flowchart of a method of fabricating a light-emitting discharge tube, according to a third embodiment of the present invention. Basically, a light-emitting discharge tube 10 is formed through the same process as the second embodiment, and thus, a detailed description thereof is omitted. In the present embodiment, as a protective film 4, an organic acid metal solution (organometallic compound solution) is coated. For the organic acid metal solution, a material that becomes a conductive metal oxide film by calcination is used. Since the protective film 4 becomes a metal oxide film by calcination, a dense, stable metal oxide film with good film quality can be formed.

Thereafter, an electron emission film 5 is formed on an inner wall surface of a glass tube 1 on which the metal oxide film is formed by calcination. The coating method for the protective film 4 includes a method of allowing a tube to pass through a coating solution, a method that uses a coating apparatus such as a roll coater, and the like, but is not particularly limited as long as the method allows the protective film 4 of a predetermined film thickness to be uniformly formed on the surface of the glass tube 1.

The protective film 4 is conductive and thus can serve as external electrodes to be formed after sealing. Specifically, the external electrodes may be formed directly using the conductive metal oxide film by performing etching such that portions corresponding to the external electrodes remain. This method can simplify the process of forming the external electrodes, making it possible to further reduce fabrication costs. Alternatively, a pattern in which portions serving as external electrodes and portions of other regions to be coated are separated may be produced by performing patterning to provide appropriate spacing that separates regions corresponding to the external electrodes from the other regions. Alternatively, all the conductive metal oxide film may be removed and external electrodes may be additionally formed.

Since the outer wall surface is coated with a conductive metal oxide film, the outer wall surface of the glass tube 1 is less susceptible to flaws, and accordingly, the glass tube 1 is less susceptible to breakage. That is, the fabrication yield of the light-emitting discharge tube 10 can be improved.

In a modified example of the present embodiment, a metal film may be formed instead of a conductive metal oxide film. Needless to say, even if the protective film 4 is a metal film, the same configuration and effects obtained by a conductive metal oxide film can be obtained.

### Fourth Embodiment

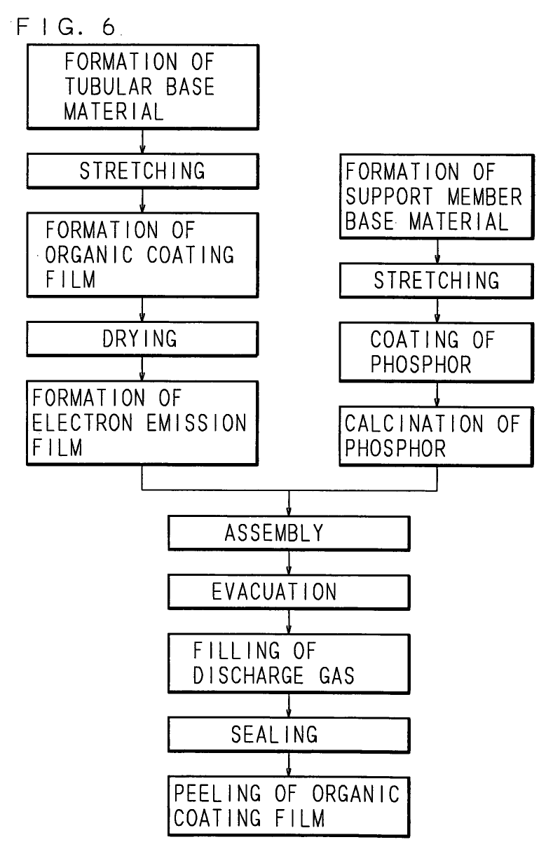

FIG. 6 is a schematic process flowchart of a method of fabricating a light-emitting discharge tube, according to a fourth embodiment of the present invention. Basically, a light-emitting discharge tube 10 is formed through the same process as the second embodiment, and thus, a detailed description thereof is omitted. In the present embodiment, as a protective film 4, an organic coating film is formed. The organic coating film becomes an organic film by drying. Since the protective film 4 is an organic film, only drying is required and calcination is not required.

In the present embodiment, after sealing, the organic coating film is peeled off and then external electrodes are formed. Since the organic film has insulating properties, depending on the physical properties of the organic film, the external electrodes can be stacked and formed on the organic film without peeling off the organic film. Alternatively, patterning may be performed such that portions other than the external electrodes remain.

### First Example

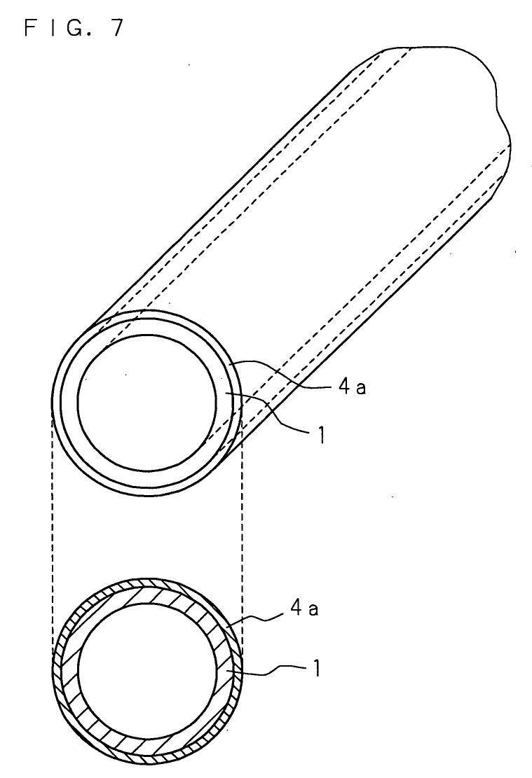

FIG. 7 is an illustrative view of a configuration of a protective film of a glass tube, according to a first example of the present invention. The schematic perspective view and schematic cross-sectional view of a glass tube 1 are shown. A state in which a metal oxide film 4a is formed on a surface of the glass tube 1 is shown. An organic acid metal solution composed of 30 parts of titanium caproate, 60 parts of ethanol, and 10 parts of propylene glycol monoethyl ether acetate is coated on the glass tube 1 into which a tubular base material is just stretched, and drying and calcination are performed, whereby a titanium oxide film of the order of 300 nm is formed on the surface of the glass tube 1. The dimensions of the glass tube 1 are 1 m in length, 1 mm in tube outside diameter, and 0.05 mm in wall thickness; however, by coating the titanium oxide film, the glass tube becomes far less susceptible to breakage. Note that by changing the mixing ratio of ethanol, the viscosity of an organic acid metal solution upon coating can be changed, and accordingly, the thickness of the metal oxide film 4a can be appropriately adjusted.

### Second Example

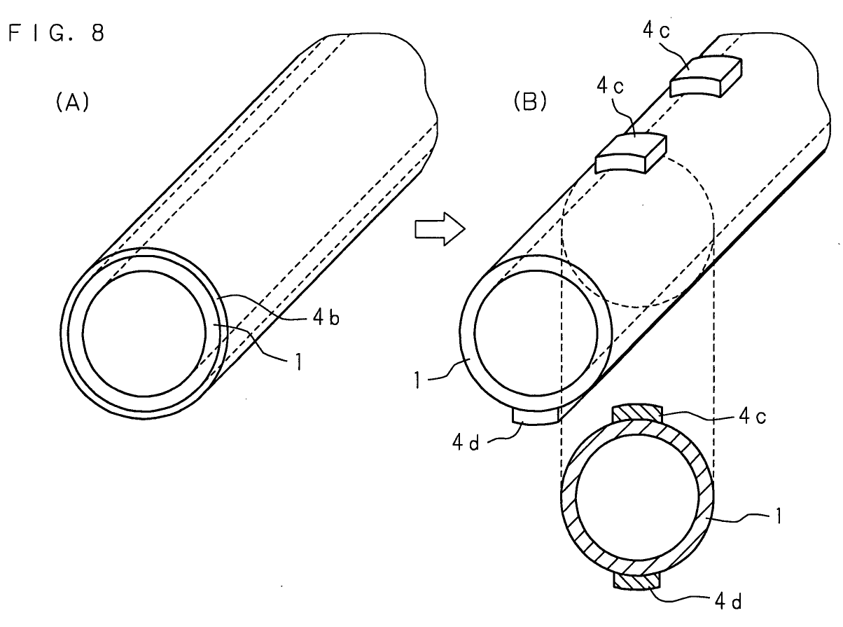

FIG. 8 is an illustrative view of a configuration of a protective film of a glass tube, according to a second example of the present invention. The schematic perspective view and schematic cross-sectional view of a glass tube 1 are shown. On the left (A) of the drawing is shown a state in which a conductive metal oxide film 4b is formed on a surface of the glass tube 1, and on the right (B) of the drawing is shown a state in which conductive metal oxide films 4c, 4d serving as external electrodes are formed by performing patterning on the conductive metal oxide film 4b by a photolithograph technique. The conductive metal oxide films 4c correspond to discharge electrodes (2) and the conductive metal oxide film 4d corresponds to an address electrode (3).

An organic acid metal solution composed of 30 parts of tin caproate, 60 parts of 1-propanol, and 10 parts of propylene glycol monoethyl ether acetate is coated on the glass tube 1 into which a tubular base material is just stretched, and drying and calcination are performed, whereby a tin oxide film of the order of 300 nm is formed on the surface of the glass tube 1. The dimensions of the glass tube 1 are 1 m in length, 1 mm in tube outside diameter, and 0.08 mm in wall thickness; however, by coating the tin oxide film, the glass tube becomes far less susceptible to breakage. Note that by changing the mixing ratio of ethanol, the viscosity of an organic acid metal solution upon coating can be changed, and accordingly, the thickness of the metal oxide film 4b can be appropriately adjusted.

After sealing is completed, a positive-type photoresist is coated on a surface of the metal oxide film 4b and ultraviolet (UV) irradiation is performed through a photomask having a pattern of external electrodes. After the photoresist is developed, the tin oxide film is etched to form external electrodes (the conductive metal oxide films 4c and the conductive metal oxide film 4d) of tin oxide on the surface of the glass tube 1.

### Fifth Embodiment

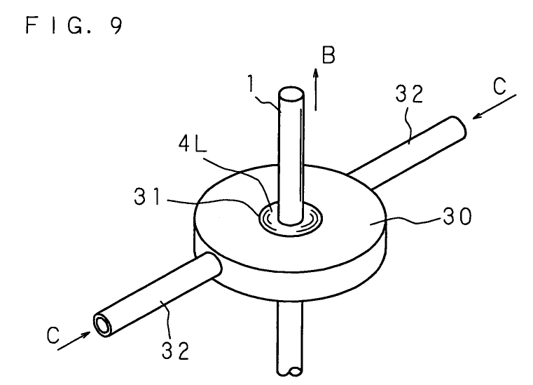

FIG. 9 is a schematic perspective view of a protective film forming apparatus according to a fifth embodiment of the present invention. The protective film forming apparatus includes a frame body 30 through which a glass tube (tube body for a light-emitting discharge tube) 1 can pass. The frame body 30 has a through portion 31 formed in a size and a shape that allow a liquid (e.g., an organic acid metal solution) 4L, which is a material for coating and forming a protective film (4), to be held in the through portion 31 by the surface tension of the liquid to form a liquid pool. By moving the glass tube 1 through the through portion 31 in a traveling direction B, the protective film (4) is coated and formed on an outer wall surface of the glass tube 1. Since the thickness of the formed protective film (4) is thin, the coated liquid dries right after passing through the through portion 31. Accordingly, the protective film (4) having a stable film thickness can be formed.

The through portion 31 formed in a circular shape with respect to a tube outside diameter of the glass tube 1 of 1 to 2 mm has a diameter of the order of 3 mm. The length (the thickness of the frame body 30) in the traveling direction B of the glass tube 1 is the order of 5 mm. The dimensions (the diameter, length, and the like) of the through portion 31 may be appropriately set according to the shape of the glass tube 1 and the surface tension (viscosity) of the liquid 4L. Since the surface tension is utilized, the protective film (4) can be formed which can be very easily controlled and which has a precise and uniform film thickness.

In a side surface of the frame body 30 is provided a supply passage (supply tube) 32 for supplying the liquid 4L to a liquid pool (the through portion 31). The liquid 4L is supplied in a direction of a supply direction C and the coating and formation of the protective film (4) in the through portion 31 can be continuously and stably performed. Accordingly, a protective film forming apparatus with a simple structure that is capable of precisely controlling the formation of the protective film (4) is obtained.

### INDUSTRIAL APPLICABILITY

By forming a protective film on an outer wall surface of a glass tube, the outer wall surface of the glass tube is made less susceptible to flaws, and accordingly, a light-emitting discharge tube that is less susceptible to breakage can be provided. Thus, the yield can be improved and the fabrication costs can be significantly reduced. In addition, a fabrication method for fabricating such an excellent light-emitting discharge tube is provided. Furthermore, a protection film forming apparatus for forming a protective film on an outer wall surface of a light-emitting discharge tube can be provided.

1-10. (canceled)

11. A light-emitting discharge tube comprising:
a tube body;
a plurality of external electrodes provided on an outer wall surface of the tube body, for defining light-emitting discharge regions; and
a protective film formed on the outer wall surface of the tube body.

12. The light-emitting discharge tube according to claim 1, wherein
the protective film is a film selected from the group consisting of a metal film, a conductive metal oxide film, an insulating metal oxide film, and an organic film.

13. The light-emitting discharge tube according to claim 2, wherein the protective film is subjected to patterning to form the external electrodes.

14. A light-emitting discharge tube that defines light-emitting discharge regions by a plurality of external electrodes, wherein an outer wall surface of the light-emitting discharge tube is coated with a protective film.

15. The light-emitting discharge tube according to claim 4, wherein the protective film is a metal film, a conductive metal oxide film, an insulating metal oxide film, or an organic film.

16. The light-emitting discharge tube according to claim 5, wherein the metal film or the conductive metal oxide film is subjected to patterning to form the external electrodes.
